(19) United States
(12) Patent Application Publication
(10) Pub. No.: US 2022/0036162 A1
(43) Pub. Date: Feb. 3, 2022

(54) NETWORK MODEL QUANTIZATION METHOD AND ELECTRONIC APPARATUS

(71) Applicant: Xiamen SigmaStar Technology Ltd., Fujian (CN)

(72) Inventors: Tao XU, Zhubei City (TW); Chengwei ZHENG, Zhubei City (TW); Xiaofeng LI, Zhubei City (TW); Bo LIN, Zhubei City (TW)

(21) Appl. No.: 17/159,217

(22) Filed: Jan. 27, 2021

(30) Foreign Application Priority Data
Jul. 31, 2020 (CN) 202010763426.8

(51) Int. Cl. G06N 3/04; G06F 17/18

(52) U.S. Cl. CPC G06N 3/0472; G06N 3/08; G06F 17/18

(57) ABSTRACT

A network model quantization method includes: acquiring a target floating-point network model that is to be model quantized; determining an asymmetric quantization interval corresponding to an input value of the target floating-point network model; determining a symmetric quantization interval corresponding to a weight value of the target floating-point network model; and performing fixed-point quantization on the input value of the target floating-point network model according to the asymmetric quantization interval, and performing the fixed-point quantization on the weight value of the target floating-point network model according to the symmetric quantization interval to obtain a fixed-point network model corresponding to the target floating-point network model.

This application claims the benefit of China application Serial No. CN202010763426.8, filed Jul. 31, 2020, the subject matter of which is incorporated herein by reference.

### BACKGROUND OF THE INVENTION

### Field of the Invention

The invention relates to the technical field of artificial intelligence, and more particularly to a network model quantization method and device and an electronic apparatus.

### Description of the Related Art

Artificial intelligence (AI) is the theory, method, technology and application system that use computers or machines controlled by computers to simulate, extend and expand human intelligence, sense the environment, acquire knowledge, and use knowledge to obtain optimal results. In other words, AI is a comprehensive technology of computer science; it aims to understand the essence of intelligence and produces a novel intelligent machine capable of reacting in a way similar to human intelligence. That is, AI is the study of design principles and implementation methods of various intelligent machines, so that the machines have functions of perception, reasoning and decision-making.

The AI technology is a comprehensive subject that involves an extensive range of fields, including both hardware-level techniques and software-level techniques. The fundamental techniques of AI commonly include technologies such as sensors, dedicated AI chips, cloud computing, distributed storage, big data processing techniques, operation/interaction systems and mechatronics. Software techniques of AI primarily include machine learning techniques. Among machine learning, deep learning is a new research direction, which is introduced into machine learning to bring it closer to the original goal—AI. Deep learning is currently mainly applied in fields such as computer vision and natural language processing.

Deep learning is the learning of inner rules and displaying levels of sample data, and information obtained during such learning process provides great help for the interpretation of data such as texts, images and sounds. Training can be performed using deep learning techniques and corresponding training sets to realize network models of different functions. For example, training can be performed based on a training data set to obtain a network model for gender classification, and training can be performed based on another training data set to obtain a network model of image optimization.

With the constant development of the AI technology, network models are deployed on electronic apparatuses including smartphones and tablet computers to reinforce the processing capacity of the electronic apparatuses. For example, an electronic apparatus is allowed to optimize a captured image thereof using a deployed image optimization model to enhance image quality.

From the perspective of storage, current network models are stored using floating points, and usually need to occupy storages space of tens and hundreds of megabytes of an electronic apparatus. From the perspective of computing, the computing of floating-point data occupy a great amount of calculation resources, which easily affect normal operations of an electronic apparatus. Therefore, there is a need for a solution for reducing the size and occupied resources of a network model.

### SUMMARY OF THE INVENTION

The present application provides a network model quantization method and an electronic apparatus capable of reducing the size and occupied resources of a network model.

A network model quantization method provided by the present application includes: acquiring a target floating-point network model that needs to be model quantized; determining an asymmetric quantization interval corresponding to an input value of the target floating-point network model; determining a symmetric quantization interval corresponding to a weight value of the target floating-point network model; and performing fixed-point quantization on the input value of the target floating-point network model according to the asymmetric quantization interval and performing the fixed-point quantization on the weight value of the target floating-point network model according to the symmetric quantization model to obtain a fixed-point network model corresponding to the target floating-point network model.

An electronic apparatus provided by the present application includes a processor and a memory. The memory has a computer program stored therein, and the computer program performs the network model quantization method provided by any of the embodiments of the present application.

In the present application, a target floating-point network model is fixed-point quantized into a fixed-point network model, so that the data type is converted from a floating-point type to a fixed-point type, thus reducing the model size. Moreover, all operations in a network model are also converted from floating-point operations to fixed-point operations, further reducing occupied resources.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of an application scenario of a network model quantization method provided according to an embodiment of the present application;

FIG. 2 is a flowchart of an application scenario of a network model quantization method provided according to an embodiment of the present application;

FIG. 3 is a schematic diagram of a network model quantization interface provided according to an embodiment of the present application;

FIG. 4 is a schematic diagram of a selection sub-interface provided according to an embodiment of the present application;

FIG. 5 is a schematic diagram of an asymmetric quantization interval determined according to an embodiment of the present application;

FIG. 6 is a schematic diagram of a symmetric quantization interval determined according to an embodiment of the present application;

FIG. 7 is a schematic diagram of a topology of a related network model according to an embodiment of the present application;

FIG. 8 is a schematic diagram of a calibration data set acquired according to an embodiment of the present application;

FIG. 9 is a structural schematic diagram of an electronic apparatus provided according to an embodiment of the present application; and

FIG. 10 is a structural schematic diagram of a network model quantization device provided according to an embodiment of the present application.

### DETAILED DESCRIPTION OF THE INVENTION

It should be noted that, an example of implementing the principle of the present application in an appropriate operation environment is described below. The description below is an example of a specific embodiment of the present application, and is not to be construed as limitations to other specific embodiments of the present application that are not described herein.

The solution provided by embodiments of the present application relates to machine learning techniques of artificial intelligence (AI), and specifically relates to a post-training stage of a network model-associated details are given in the embodiments below.

In order to ensure training precision when model training is performed in current related techniques, the data type of a trained network model is usually a floating-point type. However, a larger space is need for storing floating-point data and operations of floating-point data also occupy more calculation resources. Therefore, the present application provides a network model quantization method, which is capable of quantizing a floating-point network model into a fixed-point network model. Compared to floating-point data, fixed-point data occupies a smaller storage space and also uses less calculation resources.

A network model quantization method and an electronic apparatus are provided according to embodiments of the present application. In one embodiment, program codes are executed by a processor to implement the network model quantization method of the present application.

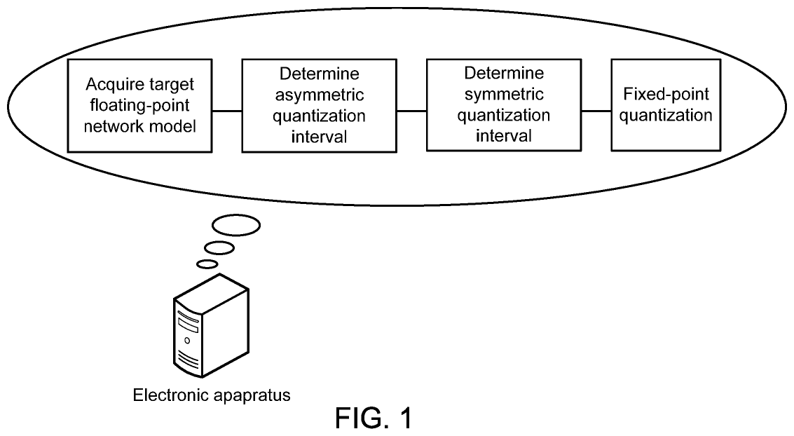

Referring to FIG. 1, FIG. 1 shows a schematic diagram of an application scenario of a network model quantization method provided according to an embodiment of the present application, and applying the network model quantization method to an electronic apparatus embodied as a desktop computer is taken as an example. Referring to FIG. 9, in an embodiment, an electronic apparatus 400 includes a processor 401 and a memory 402. The processor 401 may be a general purpose processor or may be a specific processor, e.g., a neural network processor. The memory 402 has computer program codes stored therein, and may be a high-speed random access memory or may be a non-volatile memory. The electronic apparatus 40 implements the network model quantization method of the present application by executing the computer program codes in the memory 402 by the processor 401.

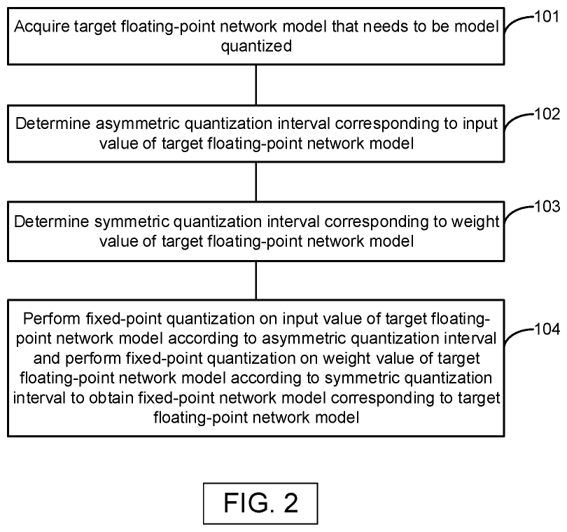

Referring to FIG. 2, FIG. 2 shows a flowchart of a network model quantization method provided according to an embodiment of the present application. Associated details are given below.

In step S101, a target floating-point network model that needs to be model quantized is acquired.

In an embodiment of the present application, an electronic apparatus first needs to acquire a target floating-point network model that needs to be network model quantized. In an embodiment of the present application, the source of the target floating-point network model is not specifically limited, and may be a floating-point network model having been trained by the electronic apparatus, or a floating-point network model having been trained by other electronic apparatuses. For example, the electronic apparatus may acquire, according a model quantization instruction inputted by a user, a target floating-point network model that needs to be model quantized, or may acquire, according to a received model quantization request upon receiving the model quantization request transmitted from other electronic apparatuses, a target floating-point network model that needs to be model quantized.

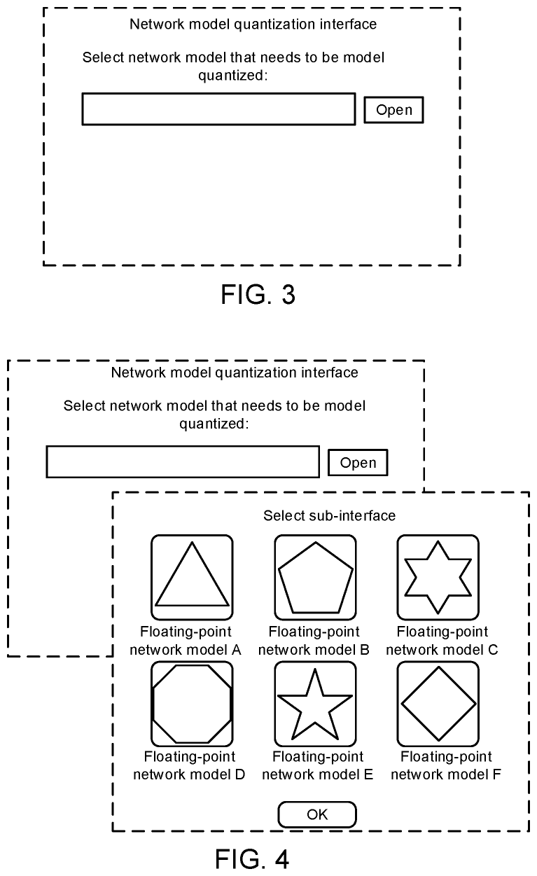

For example, the electronic apparatus may receive a model quantization instruction inputted through a network model quantization interface including an instruction input interface. As shown in FIG. 3, the instruction input interface may be in form of a input box, and a user may input, in the instruction input interface in form of an input box, model identification information of the floating-point network model that needs to be model quantized, and input confirmation information (e.g., directly clicking an OK key on the keyboard) to input the model quantization instruction to the electronic apparatus, wherein the model quantization instruction carries the model identification information of the floating-point network model that needs to be model quantized, and instructs the electronic apparatus to use a floating-point network model corresponding to the identification information as the target floating-point network model. Moreover, the network model quantization interface further includes prompt information “select network model that needs to be model quantized”.

For another example, the network model quantization interface shown in FIG. 3 further includes an “open” control item, and the electronic apparatus overlayingly displays a selection sub-interface (as shown in FIG. 4) on the network model quantization interface upon detecting that the open control item is triggered. The selection sub-interface provides icons of locally stored floating-point network models for performing model quantization to the user, for example, icons of floating-point network models including a floating-point network model A, a floating-point network model B, a floating-point network model C, a floating-point network model D, a floating-point network model E and a floating-point network model F, for the user to check and select the floating-point network model that needs to be model quantized. In addition, after selecting the icon of the floating-point network model that needs to be model quantized, the user may trigger an OK control item provided by the selection sub-interface to input a model quantization instruction into the electronic apparatus. The model quantization instruction is associated with the icon of the floating-point network model selected by the user, and instructs the electronic apparatus to use the floating-point network model selected by the user as the target floating-point network model that needs to be model quantized.

For another example, the electronic apparatus receives a model quantization request transmitted from other electronic apparatuses, and analyzes the model identification information carried in the model quantization request, wherein the model identification information indicates the target floating-point network model that needs to be model quantized. Correspondingly, the electronic apparatus acquires locally or from other electronic apparatus according to the model identification information the target floating-point network model that needs to be model quantized.

It should be noted that, the structure of the target floating-point network model that needs to be model quantized in the embodiments of the present application is not limited, and may be, for example but not limited to, a deep neural network model, a loop neural network model and a convolutional neural network model.

In step 102, an asymmetric quantization interval corresponding to an input value of the target floating-point network model is determined.

An input value quantization interval determination policy is configured in advance in the embodiment of the present application. The input value quantization interval determination policy describes how to determine a quantization interval of an input value of the target floating-point network model.

In the embodiment of the present application, the input value quantization interval determination policy is configured for determining an asymmetric quantization interval including a negative quantization parameter and a positive quantization parameter, wherein the negative quantization parameter is a minimum of the asymmetric quantization interval and the positive quantization parameter is a maximum of the asymmetric quantization interval, and an absolute value of the negative quantization parameter is not equal to an absolute value of the positive quantization parameter.

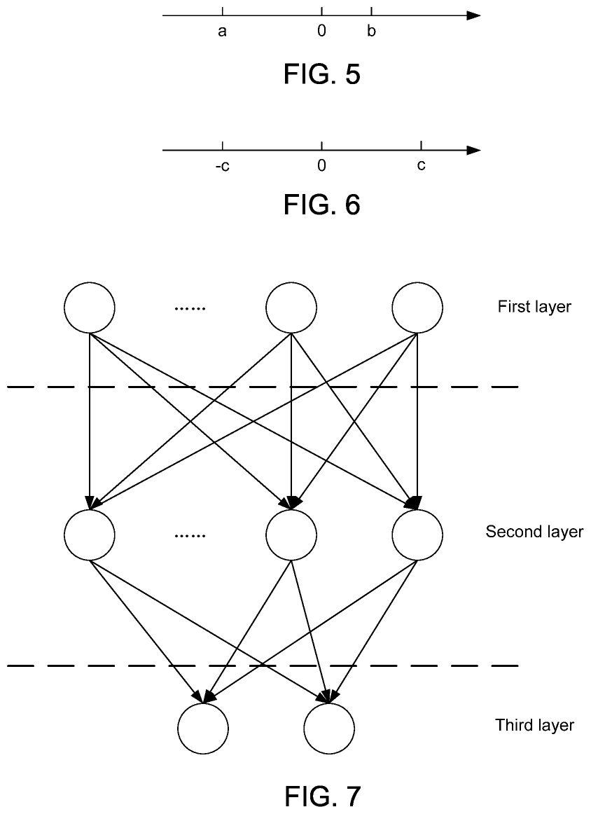

For example, referring to FIG. 5, it is determined that the asymmetric quantization interval corresponding to the input value of the target floating-point network model is [a, b], where a (a negative quantization parameter) and b (a positive quantization parameter) are real numbers, a is a negative value, b is a positive value, and |a|≠|b|.

In step 103, a symmetric quantization interval corresponding to a weight value of the target floating-point network model is determined.

A weight value quantization interval determination policy is further configured in advance in the embodiment of the present application. The weight value quantization interval determination policy describes how to determine a quantization interval of a weight value of the target floating-point network model. In the embodiment of the present application, to differentiate from the input value quantization determination policy, the weight value quantization determination policy is configured for determining a symmetric quantization interval including a negative quantization parameter and a positive quantization parameter, wherein the negative quantization parameter is a minimum of the symmetric quantization interval and the positive quantization parameter is a maximum of the symmetric quantization interval, and an absolute value of the negative quantization parameter is equal to an absolute value of the positive quantization parameter.

For example, referring to FIG. 6, it is determined that the symmetric quantization interval corresponding to the weight value of the target floating-point network model is [−c, c], where c is a real number and is a positive value, −c represents the negative quantization parameter, and c represents the positive quantization parameter.

It should be noted that, the order for performing step 102 and step 103 above is not affected by the numerals; step 102 may be performed before step 103, or step 102 may be performed after step 103, or step 102 and step 103 may be simultaneously performed.

In step 104, fixed-point quantization is performed on the input value of the target floating-point network model according to the asymmetric quantization interval, and the fixed-point quantization is performed on the weight value of the target floating-point network model according to the symmetric quantization interval to obtain a fixed-point network model corresponding to the target floating-point network model.

In the embodiment of the present application, after having determined the asymmetric quantization interval corresponding to the input value of the target floating-point network model, and having determined the symmetric quantization interval corresponding to the weight value of the target floating-point network model, the electronic apparatus performs fixed-point quantization on the input value of the target floating-point network model according to the determined asymmetric quantization interval to thereby convert the input value of the target floating-point network model from a floating-point type to a fixed-point type; the electronic apparatus further performs the fixed-point quantization on the weight value of the target floating-point network model according to the determined symmetric quantization interval to thereby convert the weight value of the target floating-point network model from a floating-point type to a fixed-point type, accordingly obtaining a fixed-point network model corresponding to the target floating-point network model.

Thus, the target floating-point network model is fixed-point quantized into a fixed-point network model, so that the data type is converted from a floating-point type to a fixed-point type, hence reducing the model size. Moreover, all operations in a network model are also converted from floating-point operations to fixed-point operations, further reducing occupied resources.

In one embodiment, the process of determining an asymmetric quantization parameter corresponding to the input value of the target floating-point network model includes acquiring a first target quantization precision corresponding to an input value of at least one network layer of the target floating-point network model, and determining the asymmetric quantization interval corresponding to the input value of the network layer of the target floating-point network model according to the first target quantization precision of the input value of the network layer of the target floating-point network model.

A person skilled in the art could understand that a network model is layered, that is, a network model may be divided into different layers according to execution logic during reasoning of the network model. For example, referring to FIG. 7, the network model in the drawing consists of three network layers. In FIG. 7, circles represent different operands, and a connecting line between any two circles represents the connection and data flow direction between the two corresponding operands. Correspondingly, to reduce precision loss of the network model after quantization, the fixed-point quantization is performed using layers as targets in the embodiment of the present application.

To determine an asymmetric quantization interval corresponding to the input value of the target floating-point network model, the electronic apparatus first acquires a quantization precision corresponding to an input value of each layer of the target floating-point network model, and denotes the quantization precision as a first target quantization precision.

It should be noted that, the quantization precision describes the data type after quantization. In the present application, kIB is used to represent the first target quantization precision; for example, IB-UkIB means that an input value is to be quantized into a kIB-bit integer without a positive/negative sign, and IB-SkIB means that an input value is to be quantized into a kIB-bit integer with a sign, where kIB is an integer, U represents the absence of a sign, and S represents the presence of a sign.

In the embodiment of the present application, the first quantization precisions corresponding to input values of different layers in the target floating-point network model may be the same or different. As the quantization precision configured gets higher, precision loss of a model after quantization becomes smaller, with however occupied resources becoming larger. For example, the first target quantization precision may be configured as IB-U4 (meaning that the input value is to be quantized into a 4-bit integer without a positive/negative sign) and IB-U8 (meaning that the input value is to be quantized into an 8-bit integer without a positive/negative sign).

In addition, the electronic apparatus further determines the asymmetric quantization interval corresponding to the input value of each layer of the target floating-point network model according to the first target quantization precision of the input value of each layer of the target floating-point network model and the configured input value quantization interval determination policy.

In one embodiment, the process of performing fixed-point quantization on the input value corresponding to the target floating-point network model according to an asymmetric quantization interval may include performing the fixed-quantization on the input value of each layer of the target floating-point network model according to an asymmetric quantization interval corresponding to the input value of each layer of the target floating-point network model.

It should be noted that, each layer mentioned in the embodiment of the present application refers to each layer that needs quantization, which may be partial layers of the target floating-point network model or all layers of the target floating-point network model, and may be specifically configured by a person skilled in the art according to actual requirements.

In one embodiment, the process of determining an asymmetric quantization interval corresponding to the input value of the network layer of the target floating-point network model according to the first target quantization precision of the input value of the network layer of the target floating-point network model may include: determining an asymmetric quantization interval corresponding to the input value of the network layer of the target floating-point network model according to a first target quantization precision of the input value of the network layer of the target floating-point network model and a goal of minimizing a mean square error of the input value before and after the quantization.

Optionally, an input value quantization interval determination policy is further provided in the embodiment of the present application. The goal of determining the input value quantization interval is to minimize the mean square error of the input value before and after the quantization, and may be expressed as the following optimization problem:

$${arg min}_{min ( {r}_{1} , 0 ) \leq a \leq 0 \leq b \leq max ( {r}_{2} , 0 ) } ( \frac{1}{{N}^{I B}} {\sum }_{i = 1}^{{N}^{IB}} {( {r}_{i }^{IB} - {\hat{r}}_{i}^{IB} )}^{2} ) ;$$

$${\hat{r}}_{i}^{IB} = {q}_{i}^{I B} \cdot {S}^{I B} + a ;$$

$${q}_{i}^{I B} = round ( \frac{clip ( {r}_{i}^{I B} ; a , b ) - a}{{S}^{I B}} ) ;$$

$${S}^{I B} = \frac{b - a}{{2}^{{k}_{I B}} - 1} ;$$

wherein, for the input value of one layer, N^{IB} represents the number of input values of the layer, r₁ represents a minimum of the input value of the layer before quantization, r₂ represents a maximum of the input value of the layer before quantization, S^{IB} represents a quantization scale for quantization of the input value of the layer, b (a positive real number) represents the positive quantization parameter of the asymmetric quantization parameter corresponding to the input value of the layer, a (a negative real number) represents the negative quantization parameter of the asymmetric quantization interval corresponding to the input value of the layer, qᵢ^{IB} represents the i^{th} input value of the layer after quantization, rᵢ^{IB} represents the i^{th} input value of the layer before quantization, argmin ( ) represents a minimum function, round ( ) represents an integer function, clip ( ) represents a clip function for converting by force a value outside a range into a value inside the range, and clip (rᵢ^{IB}, a, b)=min (max (rᵢ^{IB}; B, a), b).

Thus, by solving the problem above, optimal solutions of a and b are determined to thereby obtain the asymmetric quantization interval [a, b] corresponding to the input value of the layer. It should be noted that, the values of r₁ and r₂ may be obtained using a calibration data set.

In the embodiment of the present application, performing the fixed-point quantization on the input value of a network layer of the target floating-point network model according to an asymmetric quantization interval corresponding to the input value of the network layer of the target floating-point network model may be represented as:

$$clip ( {r}_{i}^{I B} ; a , b ) = min ( max ( {r}_{i}^{I B} , a ) , b ) ;$$

$${S}^{I B} = \frac{b - a}{{2}^{{k}_{I B}} - 1} ;$$

$${q}_{i}^{I B} = round ( \frac{clip ( {r}_{i}^{I B} ; a , b ) - a}{{S}^{I B}} ) .$$

It is seen that the value range of the input value after quantization is {0, 1, . . . , 2^{IB}−1}, for example, when the first target quantization precision corresponding to the input value of a layer is valued as 8, the value range of the input value of the layer is {0, 1, . . . , 255}.

In one embodiment, the process of determining an asymmetric quantization interval corresponding to the input value of a network layer of the target floating-point network model includes: performing, according to a first target quantization precision of the input value of a network layer of the target floating-point network model and a goal of minimizing the mean square error of the input value before and after quantization, joint search using a golden section search algorithm for a negative quantization parameter and a positive quantization parameter corresponding to the input value of each layer of the target floating-point network model.

As described above, the asymmetric quantization interval of the input value of each layer of the target floating-point network model consists of a negative quantization parameter and a positive quantization parameter, and may be represented as [a, b].

It should be noted that, for the input value of a layer, when the positive quantization parameter b of the asymmetric quantization interval [a, b] is fixed to b+, the corresponding negative quantization parameter a can be obtained from [min (r₁, 0), 0] by quick search using golden section search; when b+ is successively valued from [0, max(r₂, 0), the mean square error of the input value after quantization is a convex function of b+.

When the negative quantization parameter a of the asymmetric quantization interval [a, b] is fixed to a−, the positive quantization parameter can be obtained from [0, max(r₂, 0)] by quick search using golden section search; when a− is successively valued from [min(r₁, 0), 0], the mean square error of the input value after quantization is a convex function of a−.

According to the features above, to determine an asymmetric quantization interval corresponding to an input value of a layer of the target floating-point network model, the electronic apparatus may perform, according to a first target quantization precision of the input value of a network layer of the target floating-point network model and a goal of minimizing a mean square error of the input value before and after quantization, joint search using a golden section search algorithm for a negative quantization parameter and a positive quantization parameter corresponding to the input value of the network layer of the target floating-point network model, to correspondingly obtain optimal solutions of a negative quantization parameter and a positive quantization parameter corresponding to the input value of each layer of the target floating-point network model.

Optionally, in one embodiment, the process of performing joint search using a golden section search algorithm for a negative quantization parameter and a positive quantization parameter corresponding to an input value of each network layer of the target floating-point network model includes the following procedures:

(1) determining an initial search range for the negative quantization parameter;

(2) performing first golden section search within the initial search range for the negative quantization parameter to obtain a first candidate negative quantization parameter and a second candidate negative quantization parameter, and performing search using a golden section searching algorithm to obtain a first candidate positive quantization parameter corresponding to the first candidate negative quantization parameter and a second candidate positive quantization parameter corresponding to the second candidate negative quantization parameter, respectively;

(3) determining, according to the first candidate negative quantization parameter, the first candidate positive quantization parameter, the second candidate negative quantization parameter and the second candidate positive quantization parameter, an updated search range for performing a next round of golden section search, performing a second round of golden section search within the updated search range for the negative quantization parameter, and iterating accordingly till the negative quantization parameter is found; and

(4) performing search using the golden section search algorithm to obtain a positive quantization parameter corresponding to the negative quantization parameter.

In the embodiment of the present application, to perform joint search using the golden section search algorithm for a negative quantization parameter and a positive quantization parameter corresponding to the input value of each layer of the target floating-point network model, the electronic apparatus first determines an initial search range for the negative quantization parameter, for example, directly determining an initial search range for the negative quantization parameter as [min (r₁, 0), 0]. Then, the electronic apparatus performs a first round of golden section search within the initial search range for the negative quantization parameter to obtain a first candidate negative quantization parameter and a second candidate negative quantization parameter, and performs search using the golden section search algorithm to respectively obtain a first candidate positive quantization parameter corresponding to the first candidate negative quantization parameter (that is, a candidate positive quantization parameter that minimizes the input value before and after quantization after the second candidate negative quantization parameter has been determined) and a second candidate positive quantization parameter corresponding to the second candidate negative quantization parameter (that is, a candidate positive quantization parameter that minimizes the input value before and after quantization after the second candidate negative quantization parameter has been determined). Next, the electronic apparatus determines, according to the first candidate negative quantization parameter, the first candidate positive quantization parameter, the second candidate negative quantization parameter and the second candidate positive quantization parameter, an updated search range for performing a next round of golden section search, performs a second round of golden section search within the updated search range for the negative quantization parameter, and iterates accordingly until the negative quantization parameter is found. The electronic apparatus then performs search using the golden section search algorithm to obtain a positive quantization parameter corresponding to the negative quantization parameter.

In one embodiment, the process of determining an asymmetric quantization interval corresponding to the input value of each layer of the target floating-point network model according to a first target quantization precision of the input value of a network layer of the target floating-point network model includes: (1) acquiring a calibration data set, and acquiring statistical distribution of the input value of each layer of the target floating-point network model before quantization; and (2) determining an asymmetric quantization interval corresponding to the input value of a network layer of the target floating-point network model according to a first target quantization precision of the input value of each layer of the target floating-point network model and a goal of minimizing a Kullback-Leibler (KL) divergence of the statistical distribution of the input value before and after quantization.

Optionally, an input value quantization determination policy is further provided in the embodiment of the present application. The goal of determining the input quantization interval is to minimize the KL divergence of the statistical distribution of the input value before and after quantization, which may be expressed as the following optimization problem:

$${arg min}_{min ( {r}_{1} , 0 ) \leq a \leq 0 \leq b \leq max ( {r}_{2} , 0 ) } {D}_{K L} ( {r}^{I B} , {q}^{I B} ) = {arg min}_{min ( {r}_{1} , 0 ) \leq a \leq 0 \leq b \leq max ( {r}_{2} , 0 ) } ( {\sum }_{i = 1}^{{N}^{I B}} P ( {r}^{I B} = {r}_{i}^{I B} ) log \frac{P ( {r}^{I B} = {r}_{i}^{I B} )}{P ( {q}^{I B} = {q}_{i}^{I B} )} ) ;$$

$${q}_{i}^{I B} = round ( \frac{clip ( {r}_{i}^{I B} ; a , b ) - a}{{S}^{I B}} ) ;$$

$${S}^{I B} = \frac{b - a}{{2}^{{k}_{IB}} - 1} ;$$

wherein, for an input value of a layer, D_{LK}(r^{IB}, q^{IB}) represents the KL divergence of statistical distribution of the input value of the layer before and after quantization, N^{IB} represents the number of the input value of the layer, r₁ represents a minimum of the input value of the layer before quantization, r₂ represents a maximum of the input value of the layer before quantization, S^{IB} represents a quantization scale of quantization on the input value of the layer, b represents the positive quantization parameter of the asymmetric quantization interval corresponding to the input value of the layer, a represents the negative quantization parameter of the asymmetric quantization interval corresponding to the input value of the layer, qᵢ^{IB} represents the i^{th} input value of the layer after quantization, rᵢ^{IB} represents the i^{th} input value of the layer before quantization, round ( ) represents an integer function, and clip ( ) represents a clip function for converting by force a value outside a range to a value inside the range, and clip (rᵢ^{IB}, a, b)=min (max(rᵢ^{IB}, a), b).

Correspondingly, optimal solutions of a and b are determined by solving the problem above to thereby obtain the asymmetric quantization interval [a, b] corresponding to the input value of the layer.

It should be noted that, the values of r₁ and r₂ may be obtained using a calibration data set; that is, a calibration data set is inputted into the target floating-point network model for deduction to correspondingly acquire a value range [r₁, r₂] of the input value of a network layer.

In the embodiment of the present application, the performing the fixed-point quantization on the input value of a network layer of the target floating-point network model according to an asymmetric quantization interval corresponding to the input value of the network layer of the target floating-point network model may be represented as:

$$clip ( {r}_{i}^{I B} ; a , b ) = min ( max ( {r}_{i}^{I B} , a ) , b ) ;$$

$${S}^{I B} = \frac{b - a}{{2}^{{k}_{I B}} - 1} ;$$

$${q}_{i}^{I B} = round ( \frac{clip ( {r}_{i}^{I B} ; a , b ) - a}{{S}^{I B}} ) .$$

In one embodiment, the process of determining an asymmetric quantization interval corresponding to an input value of a network layer of the target floating-point network model includes: (a) determining multiple search widths corresponding to the input value of the network layer of the target floating-point network model according to a first target quantization precision; and (2) searching, according to a goal of minimizing the KL divergence of the statistical distribution of the input value before and after quantization, within the multiple search widths using a golden section search algorithm for an asymmetric quantization interval corresponding to the input value of the network layer of the target floating-point network model.

As described above, the asymmetric quantization interval corresponding to the input value of each layer of the target floating-point network model consists of a negative quantization parameter and a positive quantization parameter.

It should be noted that, for an input layer of a layer, to determine an asymmetric quantization interval [a, b] thereof according to a goal of minimizing the KL divergence of the statistical distribution of the input value before and after quantization, an input value before quantization is divided in advance into B bins, where B is an integer multiple of 2^{k}^{_{IB}}, and may be represented as B=B₀*2^{k}^{_{IB}}. Correspondingly, the width of the asymmetric quantization interval may be determined by selecting the number of bins. Correspondingly, to search for the optimal solution of the asymmetric quantization interval, only widths corresponding to bins that are integer multiples of 2^{k}^{_{IB}} need to be searched, that is, only the B0 widths that are b−a={2^{k}^{_{IB}}, (B0−1)*2^{k}^{_{IB}}, . . . , 2*2^{k}^{_{IB}}, 1*2^{k}^{_{IB}}} need to be searched, which are expressed as the search width. For each fixed search width, the search for the asymmetric quantization interval [a, b] is degenerated to a one-dimensional search, and the optimal solution of the asymmetric quantization interval [a, b] can be obtained using the golden section search method.

Correspondingly, to determine an asymmetric quantization interval corresponding to the input value of each layer of the target floating-point network model according to a first target quantization precision and a goal of minimizing the KL divergence of the statistical distribution of the input value before and after quantization, the electronic apparatus may determine multiple search widths corresponding to the input value of each layer of the target floating-point network model according to the first target quantization precision, and then perform search within the multiple search ranges using the golden section search algorithm according to a goal of minimizing the KL divergence of the statistical distribution of the input value before and after quantization to obtain an asymmetric quantization interval corresponding to the input value of a network layer of the target floating-point network model.

The value of B is not limited in the embodiment of the present application, and may be an experience value determined by the person skilled in the art according to the processing capacity of the electronic apparatus.

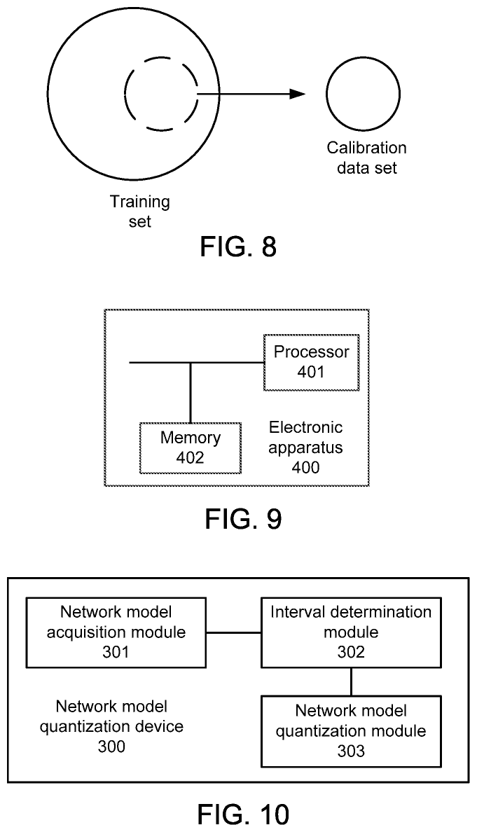

In one embodiment, the process of acquiring a calibration data set includes: (1) acquiring a training set for training the target floating-point network model; and (2) extracting a subset of the training set as the calibration data set. When the training set for training the target floating-point network model can be acquired, the electronic apparatus may first acquire a training set for training the target floating-point network model, and directly extract from the training set a subset as the calibration data set, as shown in FIG. 8. It should be noted that, in the embodiment of the present application, the method for extracting the subset is not specifically limited, and may be specifically configured by a person skilled in the art according to actual requirements.

In one embodiment, the process of acquiring a calibration data set includes: (1) acquiring a distribution feature of network parameters in the target floating-point network model; (2) generating a target data set according to the distribution feature, wherein data distribution of the target data set matches with data distribution of the training set for training the target floating-point network model; and (3) using the target data set as the calibration data set.

In the embodiment of the present application, when the training set for training the target floating-point network model cannot be acquired, the electronic apparatus may generate, according to network properties of the target floating-point network model, a data set that approximates the data distribution of the training set as the calibration data set. The electronic apparatus first analyzes network parameters in the target floating-point network model to obtain the distribution feature thereof, then generates a data set that matches the data distribution of the training set for training the target floating-point network model, and uses the data set as the calibration data set.

In one embodiment, the process of determining a symmetric quantization interval corresponding to the weight value of the target floating-point network model includes: acquiring a second target quantization precision corresponding to the weight value of a network layer of the target floating-point network model; and determining a symmetric quantization interval corresponding to the weight value of each layer of the target floating-point network model according to a second target quantization precision of the weight value of each layer of the target floating-point network model. The process of performing the fixed-point quantization on the weight value of the target floating-point network model according to the symmetric quantization interval includes: performing the fixed-point quantization on the weight value of a network layer of the target floating-point network model according to a symmetric quantization interval corresponding to the weight value of a network layer of the target floating-point network model.

In the embodiment of the present application, in order to reduce precision loss of the network model after quantization, the fixed-point quantization of the weight value is performed by using a layer as a target in the embodiment of the present application. To determine a symmetric quantization parameter corresponding to the weight value of the target floating-point network model, the electronic apparatus first acquires a quantization precision corresponding to the weight value of each layer of the target floating-point network model, and denotes the quantization precision as a second target quantization precision.

It should be noted that, the quantization precision describes the data type after quantization, and the present application uses k_{KB} to represent the second quantization precision. For example, KB-Uk_{KB} means that a weight value is to be quantized into a k_{KB}-bit integer without a positive/negative sign, KB-Sk_{KB} means that a weight value is to be quantized into a k_{KB}-bit integer with a sign, where k_{KB} is an integer, U represents the absence of a sign, and S represents the presence of a sign.

In the embodiment of the present application, the second target quantization parameters corresponding to weight values of different layers in the target floating-point network model may be the same or different. As the quantization precision configured gets higher, precision loss of a model after quantization becomes smaller, with however occupied resources becoming larger. For example, the second target quantization precision may be configured as KB-S4 (meaning that the weight value is to be quantized into a 4-bit integer with a sign) and KB-S8 (meaning that the input value is to be quantized into an 8-bit integer with a sign).

In addition, the electronic apparatus further determines the second target quantization precision corresponding to the weight value of each layer of the target floating-point network model according to a second target quantization precision of the weight value of a network layer of the target floating-point network model and a configured weight value quantization interval determination policy.

Correspondingly, to perform the fixed-point quantization on the weight value of the target floating-point network model, the electronic apparatus may perform the fixed-point quantization on the weight value of a network layer of the target floating-point network model according to a symmetric quantization interval corresponding to the weight value of the network layer of the target floating-point network model.

In one embodiment, the process of determining a symmetric quantization parameter corresponding to the weight value of a network layer of the target floating-point network model includes: determining a second target quantization precision of the weight value of a network layer of the target floating-point network model, and determining a symmetric quantization interval corresponding to the weight value of the network layer according to a second target quantization precision of the weight value of the network layer of the target floating-point network model and a goal of minimizing a mean square difference of the weight value before and after quantization.

Optionally, a weight value quantization interval determination policy is further provided in the embodiment of the present application. The goal of determining the weight value quantization interval is to minimize the mean square error of the weight value before and after quantization, which may be expressed as the following optimization problem:

$${arg min}_{0 < c < max ( \vert {r}_{3} \vert , \vert {r}_{4} \vert )} ( \frac{1}{{N}^{K B}} {\sum }_{{ }^{j = 1}}^{{N}^{K B}} {( {r}_{j}^{KB} - {\hat{r}}_{j}^{KB} )}^{2} ) ;$$

$${\hat{r}}_{j}^{KB} = {q}_{j}^{K B} \cdot {S}^{K B} + c ;$$

$${q}_{j}^{K B} = round ( \frac{clip ( {r}_{j}^{K B} ; - c , c )}{{S}^{K B}} ) ;$$

$${S}^{K B} = \frac{c}{{2}^{{k}_{K B} - 1} - 1} ;$$

wherein, for the weight value of a layer, N^{KB} represents the number of weight values of the layer, r₃ represents a minimum of the weight value of the layer before quantization, r₄ represents a maximum of the weight value of the layer before quantization, S^{KB} represents a quantization scale of quantization on the weight value of the layer, c (a positive real number) represents a positive quantization parameter of the symmetric quantization interval corresponding to the weight value of the layer, −c represents a negative quantization parameter of the symmetric quantization interval corresponding to the weight value of the layer, qⱼ^{KB} represents the j^{th} weight value of the layer after quantization, rⱼ^{KB} represents the j^{th} weight value of the layer after quantization, round ( ) represents an integer function, and clip ( ) represents a clip function for converting by force a value outside a range to a value inside the range, and clip (rⱼ^{KB}; −c, c)=min (max (rⱼ^{KB}, −c), c).

Thus, by solving the problem above, an optimal solution for c is determined to thereby obtain a symmetric quantization interval [−c, c] corresponding to the weight value of the layer. In practice, the values of r₃ and r₄ may be obtained using a calibration data set.

In the embodiment of the present application, performing the fixed-point quantization on the weight value of a network layer of the target floating-point network model according to a symmetric quantization interval corresponding to the weight value of the network layer of the target floating-point network model may be expressed as:

$$clip ( {r}_{j}^{K B} ; - c , c ) = min ( max ( {r}_{j}^{K B} , - c ) , c ) ;$$

$${S}^{K B} = \frac{c}{{2}^{{k}_{K B} - 1} - 1} ;$$

$${q}_{j}^{K B} = round ( \frac{clip ( {r}_{j}^{K B} ; - c , c )}{{S}^{K B}} ) .$$

It is seen that the value range of the weight value after quantization is {−(2^{KB-1}−1), −(2^{KB-1}−2), . . . , 2^{KB-1}−1}. For example, when a second target quantization precision corresponding to the weight value of a layer is valued as 8, the value range of the weight value of the layer is {−127, −126, . . . , 127}.

In one embodiment, the process of determining a symmetric quantization interval corresponding to the weight value of a network layer of the target floating-point network model includes: performing, according to a second target quantization precision of the weight value of a network layer of the target floating-point network model and a goal of minimizing a mean square error of the weight value before and after quantization, searching using a golden section search algorithm to obtain a symmetric quantization interval of the weight value of a network layer.

As described above, the symmetric quantization interval of the weight value of each layer of the target floating-point network model consists of a negative quantization parameter and a positive quantization parameter, and may be represented as [−c, c].

It should be noted that, for a weight value of a layer, the mean square error of the weight value before and after quantization is a convex function of the positive quantization parameter c. Thus, to determine a symmetric quantization interval corresponding to the weight value of a layer of the target floating-point network model, the electronic apparatus may perform, according to a second target quantization precision of the weight value of each layer of the target floating-point network model and a goal of minimizing the mean square error of the weight value before and after quantization, search using a golden section search algorithm to obtain the positive quantization parameter c corresponding to the weight value of a network layer of the target floating-point network model, and obtain the corresponding symmetric quantization interval according to the positive quantization parameter, with the symmetric quantization interval being represented as [−c, c].

Referring to FIG. 10, FIG. 10 shows a structural schematic diagram of a network model quantization device 300 provided according to an embodiment of the present application. The network model quantization device 300 is applied to an electronic apparatus and is capable of performing the network model quantization method described above. The network model quantization device 300 includes a network model acquisition module 301, an interval determination model 302 and a network model quantization model 303. The network model acquisition module 301 acquires a target floating-point network model that needs to be model quantized. The interval determination module 302 determines an asymmetric quantization interval corresponding to an input value of the target floating-point network model, and determines a symmetric quantization interval corresponding to a weight value of the target floating-point network model. The network model quantization module 303 performs fixed-point quantization on the input value of the target floating-point network model according to the asymmetric quantization interval, and performs the fixed-point quantization on the weight value of the target floating-point network model according to the symmetric quantization interval to obtain a fixed-point network model corresponding to the target floating-point network model. The network model quantization device 300 provided according to the embodiment of the present application and the network model quantization method in the foregoing embodiment belong to the same concept; any of the methods provided in the embodiments of the network model quantization method can be performed using the network model quantization device 300, and details of the specific implementation process can be referred from the foregoing embodiments and are omitted herein.

A network model quantization method and device and an electronic apparatus provided according to the embodiments of the present application are as described in detail above. The principle and implementation details of the present application are described by way of specific examples in the literature, and the illustrations given in the embodiments provide assistance to better understand the method and core concepts of the present application. Variations may be made to specific embodiments and application scopes by a person skilled in the art according to the concept of the present application. In conclusion, the disclosure of the detailed description is not to be construed as limitations to the present application.

What is claimed is:

1. A network model quantization method, comprising:
acquiring a target floating-point network model that needs to be model quantized;
determining an asymmetric quantization interval corresponding to an input value of the target floating-point network model;
determining a symmetric quantization interval corresponding to a weight value of the target floating-point network model; and
performing fixed-point quantization on the input value of the target floating-point network model according to the asymmetric quantization interval and performing the fixed-point quantization on the weight value of the target floating-point network model according to the symmetric quantization interval to obtain a fixed-point network model corresponding to the target floating-point network model.

2. The network model quantization method according to claim 1, wherein the determining the asymmetric quantization interval corresponding to the input value of the target floating-point network model comprises:
determining the asymmetric quantization interval corresponding to the input value of the target floating-point network model according to a first target quantization precision of the input value of a network layer of the target floating-point network model.

3. The network model quantization method according to claim 2, wherein in the step of determining the asymmetric quantization interval corresponding to the input value of the target floating-point network model, the asymmetric quantization interval is determined according to a goal of minimizing a mean square error of the input value before and after quantization.

4. The network model quantization method according to claim 3, wherein in the step of determining the asymmetric quantization interval corresponding to the input value of the target floating-point network model, joint search using a golden section search algorithm for a negative quantization parameter and a positive quantization parameter corresponding to the input value of the network layer of the target floating-point network model is performed according to the goal of minimizing the mean square error of the input value before and after quantization.

5. The network model quantization method according to claim 4, wherein the performing joint search using the golden section search algorithm for the negative quantization parameter and the positive quantization parameter corresponding to the input value of the network layer of the target floating-point network model comprises:
determining an initial search range for the negative quantization parameter;
performing a first round of golden section search within the initial search range for the negative quantization parameter to obtain a first candidate negative quantization parameter and a second candidate quantization parameter, and performing search using the golden section search algorithm to respectively obtain a first candidate positive quantization parameter corresponding to the first candidate negative quantization parameter and a second candidate positive quantization parameter corresponding to the second candidate negative quantization parameter;
determining an updated search range for a next round of golden section search according to the first candidate negative quantization parameter, the first candidate positive quantization parameter, the second candidate negative quantization parameter and the second candidate positive quantization parameter, performing a second round of golden section search within the updated search range for the negative quantization parameter, and iterating accordingly until the negative quantization parameter is found; and
performing search using the golden section search algorithm to obtain the positive quantization parameter corresponding to the negative quantization parameter.

6. The network model quantization method according to claim 2, wherein the step of determining the asymmetric quantization interval corresponding to the input value of the network layer of the target floating-point network model comprises:
acquiring statistical distribution of the input value of the network layer of the target floating-point network model before quantization; and
determining the asymmetric quantization interval corresponding to the input value of the network layer of the target floating-point network model according to the first target quantization precision of the input value of the network layer of the target floating-point network model and a goal of minimizing a Kullback-Leibler (LK) divergence of the statistical distribution of the input value before and after quantization.

7. The network model quantization method according to claim 6, wherein the step of determining the asymmetric quantization interval corresponding to the input value of the network layer of the target floating-point network model comprises:
determining a plurality of search widths corresponding to the input value of the network layer of the target floating-point network model according to the first target quantization precision;
performing search within the plurality of search widths using golden section search algorithm according to the goal of minimizing the KL divergence of the statistical distribution of the input value before and after quantization to obtain the asymmetric quantization interval corresponding to the input value of the network layer of the target floating-point network model.

8. The network model quantization method according to claim 1, wherein the step of determining the symmetric quantization parameter corresponding to the weight value of the target floating-point network model comprises:
determining the symmetric quantization parameter corresponding to the weight value of a network layer of the target floating-point network model according to a second target quantization precision of the weight value of the network layer of the target floating-point network model.

9. The network model quantization method according to claim 8, wherein the step of determining the symmetric quantization parameter corresponding to the weight value of a network layer of the target floating-point network model comprises:
determining the symmetric quantization parameter corresponding to the weight value of the network layer of the target floating-point network model according to the second target quantization precision and a goal of minimizing the weight value before and after quantization.

10. The network model quantization method according to claim 8, wherein the step of determining the symmetric quantization parameter corresponding to the weight value of the network layer of the target floating-point network model comprises:
performing search using a golden section search algorithm according to the second target quantization precision and a goal of minimizing the weight value before and after quantization to obtain the symmetric quantization interval corresponding to the weight value of the network layer of the target floating-point network model.

11. An electronic apparatus, comprising a processor and a memory, the memory having a computer program stored therein, the processor executing the computer program to implement a network model quantization method, the network model quantization method comprising:
acquiring a target floating-point network model that needs to be model quantized;
determining an asymmetric quantization interval corresponding to an input value of the target floating-point network model;
determining a symmetric quantization interval corresponding to a weight value of the target floating-point network model; and
performing fixed-point quantization on the input value of the target floating-point network model according to the asymmetric quantization interval and performing the fixed-point quantization on the weight value of the target floating-point network model according to the symmetric quantization interval to obtain a fixed-point network model corresponding to the target floating-point network model.
